(19) United States
(12) Patent Application Publication
(10) Pub. No.: US 2020/0130803 A1
(43) Pub. Date: Apr. 30, 2020

(54) FRAME AND MULTI-ROTOR UNMANNED AERIAL VEHICLE

(71) Applicant: SZ DJI TECHNOLOGY CO., LTD., Shenzhen (CN)

(72) Inventors: Wenlong XIAO, Shenzhen (CN); Guibin LIANG, Shenzhen (CN)

(21) Appl. No.: 16/726,586

(22) Filed: Dec. 24, 2019

Related U.S. Application Data
(63) Continuation of application No. PCT/CN2017/099457, filed on Aug. 29, 2017.

(51) Int. Cl. B64C 1/06; B64C 39/02

(52) U.S. Cl. CPC B64C 1/063; B64C 39/024; B64C 2201/108; B64C 2201/165; B64C 2201/024; B64C 2201/20

(57) ABSTRACT

A frame and a multi-rotor unmanned aerial vehicle are provided. The frame includes a triangular arm and a center frame. An apex of the triangular arm is hinged with the center frame. The triangular arm includes a first arm, a second arm, and a telescopic arm. The first arm, the second arm, and the telescopic arm are hinged together to form a triangle. When the telescopic arm moves from an extended state to a retracted state, the triangular arm is folded toward a direction close the center frame.

### CROSS-REFERENCE TO RELATED APPLICATION

This application is a continuation of International Application No. PCT/CN2017/099457, filed at Aug. 29, 2017, the entire content of which is incorporated herein by reference.

### TECHNICAL FIELD

The present disclosure relates to the field of unmanned aerial vehicle and, more particularly, to a frame and a multi-rotor unmanned aerial vehicle.

### BACKGROUND

As technologies and economy develop continuously, unmanned aerial vehicles become more and more popular in fields of both consumption and business. Application scenarios of the unmanned aerial vehicles are diversified. Multi-rotor unmanned aerial vehicles occupy a large market share due to their simple operation and reliable performance. In existing technologies, an unmanned aerial vehicle usually includes a center frame, a plurality of arms radially distributed around a center of the center frame, and propulsion components mounted on the plurality of arms. During operation, propellers in the propulsion components rotate to provide climbing forces to the multi-rotor unmanned aerial vehicle, thereby driving the multi-rotor unmanned aerial vehicle to climb, hover or dive. However, the arms of the multi-rotor unmanned aerial vehicles in the existing technologies usually are fixed to the center frame. The multi-rotor unmanned aerial vehicles correspondingly occupy a large volume and are inconvenient for transportation or storage.

### SUMMARY

One aspect of the present disclosure provides a frame. The frame includes a triangular arm and a center frame. An apex of the triangular arm is hinged with the center frame. The triangular arm includes a first arm, a second arm, and a telescopic arm. The first arm, the second arm, and the telescopic arm are hinged together to form a triangle. When the telescopic arm is moved from an extended state to a retracted state, the triangular arm is folded toward a direction close the center frame.

Another aspect of the present disclosure provides a multi-rotor unmanned aerial vehicle. The multi-rotor unmanned aerial vehicle includes a frame and a stand. The frame includes a triangular arm and a center frame. An apex of the triangular arm is hinged with the center frame. The triangular arm includes a first arm, a second arm, and a telescopic arm. The first arm, the second arm, and the telescopic arm are hinged together to form a triangle. When the telescopic arm is moved from an extended state to a retracted state, the triangular arm is folded toward a direction close the center frame. The stand is mounted at a bottom of the center frame.

In the present disclosure, by pushing the telescopic arm of a triangular arm in the multi-rotor unmanned aerial vehicle to make the telescopic arm retracted, the triangular arm may be folded toward the center frame. Correspondingly, the volume of the frame may be reduced to facilitate the storage and the transportation of the multi-rotor unmanned aerial vehicle. By pulling the telescopic arm of a triangular arm to make the telescopic arm extended, the triangular arm may be extended, and the multi-rotor unmanned aerial vehicle can operate normally

Other aspects or embodiments of the present disclosure can be understood by those skilled in the art in light of the description, the claims, and the drawings of the present disclosure

### BRIEF DESCRIPTION OF THE DRAWINGS

FIG. 1 illustrates an exemplary multi-rotor unmanned aerial vehicle consistent with various embodiment of the present disclosure;

FIG. 2 illustrates an exemplary frame of a multi-rotor unmanned aerial vehicle consistent with various embodiment of the present disclosure;

FIG. 3 illustrates a front view of the frame in FIG. 2 for a multi-rotor unmanned aerial vehicle consistent with various embodiment of the present disclosure;

FIG. 4 illustrates forces in triangular arms when the triangular arms are folded in the multi-rotor unmanned aerial vehicle illustrated in FIG. 2;

FIG. 5 illustrates the folded triangular arms in the multi-rotor unmanned aerial vehicle illustrated in FIG. 2;

FIG. 6 illustrates an exemplary propulsion component in a multi-rotor unmanned aerial vehicle consistent with various embodiment of the present disclosure; and

FIG. 7 illustrates another exemplary propulsion component in a multi-rotor unmanned aerial vehicle consistent with various embodiments of the present disclosure.

### DETAILED DESCRIPTION OF THE EMBODIMENTS

Reference will now be made in detail to exemplary embodiments of the disclosure, which are illustrated in the accompanying drawings. Wherever possible, the same reference numbers will be used throughout the drawings to refer to the same or like parts.

Example embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

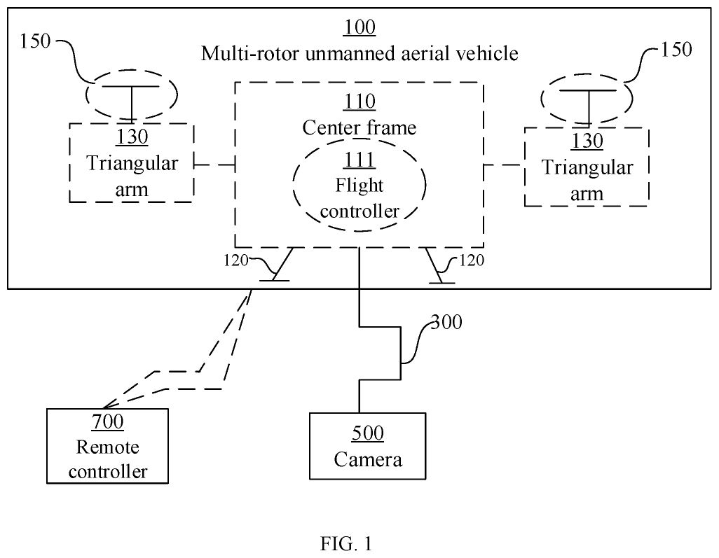

One embodiment of the present disclosure provides a multi-rotor unmanned aerial vehicle illustrated in FIG. 1. As illustrated in FIG. 1, the multi-rotor unmanned aerial vehicle 100 may include a frame and a stand 120. The frame may include a center frame 110 and triangular arms 130. The triangular arms 130 may be mounted on the center frame 110 and can be folded toward the center frame 110. The stand 120 may be mounted at a bottom of the center frame 110. When the multi-rotor unmanned aerial vehicle 100 lands on the ground, the stand 120 may support the multi-rotor unmanned aerial vehicle 100 to keep the frame away from the ground. Correspondingly, a collision of the frame with the ground can be avoided, and the safety and service life of the multi-rotor unmanned aerial vehicle 100 may be improved. In some embodiments, to avoid a collision of the stand 120 with branches or buildings when the multi-rotor unmanned aerial vehicle 100 flies, the stand 120 may be mounted at the bottom of the center frame 110 and may be foldable. Then the stand 120 may be retracted after take-off and may be extended out during the landing.

The center frame 110 can generally be designed as a box or a frame structure of any suitable shape. In some embodiments, the center frame 110 may be a rectangular or a rectangular-like box. A flight controller 111 may be disposed in the center frame 110. The flight controller 111 may include a processor and a memory. The memory may store control commands for controlling operating states of moving parts and/or sensors. The processor may process sensing information of the sensors, and read the control commands according to the processing results and generate control signals which can be recognized by the moving parts to control the moving parts to perform preset motions. The processor may also receive remote control information sent by a remote controller 700, process the remote control information, and generate control signals control the moving parts to perform corresponding motions. The processor may also control the sensors to sense environmental information and/or operation information of the multi-rotor unmanned aerial vehicle 100. In one embodiment, the remote controller 700 may be a component independent of the center frame and may be connected to the flight controller through a wireless connection. Correspondingly, operators may remotely control the multi-rotor unmanned aerial vehicle 100 on the ground.

A gimbal 300 may be mounted at the bottom or the top of the center frame 110, and different devices may be installed on the gimbal 300 for different application scenarios to expand the functionality of the multi-rotor unmanned aerial vehicle 100. In one embodiment, when aerial photography is performed using the multi-rotor unmanned aerial vehicle 100, a camera 500 may be mounted on the gimbal 300 for photographing, video recording, and the like. In another embodiment, when using the multi-rotor unmanned aerial vehicle 100 for remote sensing observation, a remote sensing device such as an infrared sensor or a night vision imager may be mounted on the gimbal 300. In another embodiment, when using multi-rotor unmanned aerial vehicle 100 for agriculture production, a spreader may be mounted on the gimbal 300 for seeding, fertilizing, or spraying pesticides. In another embodiment, when the multi-rotor unmanned aerial vehicle 100 is used to assist in construction of a suspension bridge, one end of a pilot cable can be fixed on the gimbal 300, and the multi-rotor unmanned aerial vehicle 100 may pull the pilot cable to set up a linear temporary construction access parallel to a main cable under the main cable of the suspension bridge, to facilitate the construction of the bridge.

In the present disclosure, the triangular arms 130 mounted on the center frame 110 can be folded toward the center frame 110. Correspondingly, when storing or transport the multi-rotor unmanned aerial vehicle 100, a volume occupied by the multi-rotor unmanned aerial vehicle 100 may be reduced to facilitate the store or the transportation.

For description purposes only, the embodiment illustrated in FIG. 1 where a foldable triangular arm 130 is mounted at a left side and a right side of the center frame 110 respectively is used as an example to illustrate the present disclosure and should not limit the scopes of the present disclosure. In various embodiments, the triangular arms with any suitable number may be mounted at any suitable position on the center frame 110. For example, in one embodiment, two triangular arms 130 may be mounted at a front end and a back end of the center frame 110. In various embodiments, one or more foldable triangular arms may be mounted on the center frame 110. In one embodiment, only one foldable triangular arm 130 may be mounted on the center frame 110, and one or more triangular arms 130 that cannot be folded may be further mounted on the center frame 110, to improve the lifting fore and balance of the multi-rotor unmanned aerial vehicle 100, or one or more linear, quadrilateral or other shaped arms that can be folded or cannot be folded may be further mounted on the center frame 110. In some embodiments, when a plurality of foldable triangular arms 130 may be mounted on the center frame 110, the plurality of triangular arms 130 may be evenly arranged along the circumference of the center frame 110.

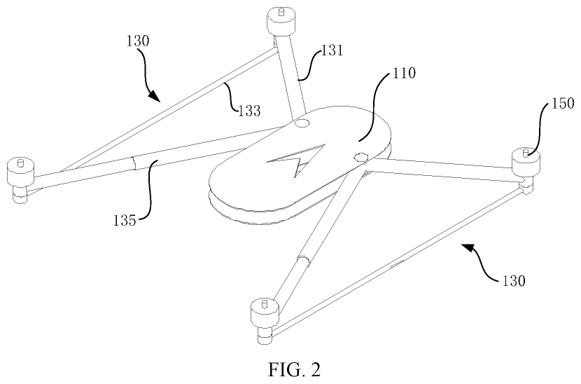

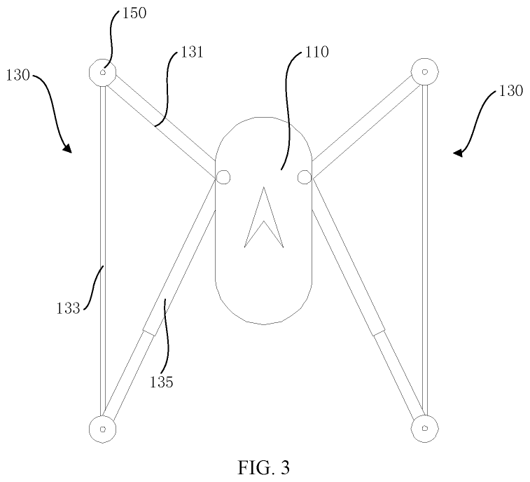

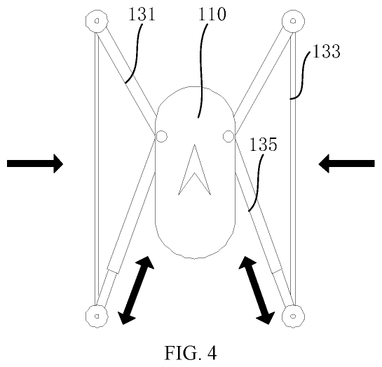

FIG. 2 illustrates an exemplary frame of a multi-rotor unmanned aerial vehicle consistent with various embodiments of the present disclosure; and FIG. 3 illustrates a front view of FIG. 2. As illustrated in FIGS. 2-3, one of the apexes of each triangular arm 130 may be hinged to the center frame 110. Each triangular arm 130 may include a first arm 131, a second arm 133, and a telescopic arm 135 hinged together to form a triangle.

For each triangular arm 130, the first arm 131, the second arm 133 and the telescopic arm 135 may be rigid arms. In one embodiment, the first arm 131, the second arm 133 and the telescopic arm 135 may be formed by stamping a metal material. In other embodiments, the first arm 131, the second arm 133 and the telescopic arm 135 may be formed by molding a plastic material. The first arm 131 may be hinged with the second arm 133 and the telescopic arm 135, and the second arm 133 may be hinged with the telescopic arm 135, to form a closed triangular between the first arm 131, the second arm 133 and the telescopic arm 135. The first arm 131, the second arm 133 and the telescopic arm 135 may be hinged together by a connecting shaft 157 or other suitable structure. For example, in one embodiment, a shaft hole may be formed at an end of the first arm 131, an end of the second arm 133 and an end of the telescopic arm 135, respectively. And then three shafts may pass through the shaft holes at the ends of the first arm 131, the second arm 133 and the telescopic arm 135, respectively, to hinge the first arm 131, the second arm 133 and the telescopic arm 135 together. In some other embodiments, the shaft holes may be formed at any suitable position within the end portion, to hinge the first arm 131, the second arm 133 and the telescopic arm 135 together. The embodiment where the first arm 131, the second arm 133 and the telescopic arm 135 are hinged together at the ends will be used as an example to illustrate the present disclosure in the following unless otherwise specified.

The first arm 131 and the second arm 133 may have hollow or solid structures. For example, the first arm 131 and the second arm 133 may be carbon fiber tubes with proper stiffness and strength. The carbon fiber tubes may have circular, elliptical or other suitable shaped cross-sections. In one embodiment, the telescopic arm 135 may include two or more sleeves that are nested together. In another embodiment, the telescopic arm 135 may include an even number of arms and every two arms may be hinged together in the middle portions to form a group. Ends of arms in two adjacent groups may be hinged together to form a telescopic structure. In various embodiments, the telescopic arm 135 may be any suitable type of telescopic structure.

In the present disclosure, for each triangular arm 130, the triangular arm 130 may be formed by hinging, and the telescopic arm 135 can extend or retract. Correspondingly, a shape of the triangle formed by the first arm 131, the second arm 133 and the telescopic arm 135 can be adjusted by adjusting a length of the telescopic arm 135, to control a shape of the triangular arm 130. Then the triangular arm 130 can be folded. That is, in the frame, the triangular arm 130 can be folded toward the center frame 110 when the telescopic arm 135 moves from an extended state to a retracted state.

As illustrated in FIGS. 2-3, for a triangular arm 130 at the left side of the center frame 110, a right end of the first arm 131 and a right end of the telescopic arm 135 may be hinged with the center frame 110, while a left end of the first arm 131 and a left end of the telescopic arm 135 may be hinged with a front end and a back end of the second arm 133 respectively. For a triangular arm 130 at the right side of the center frame 110, a left end of the first arm 131 and a left end of the telescopic arm 135 may be hinged with the center frame 110, while a right end of the first arm 131 and a right end of the telescopic arm 135 may be hinged with a front end and a back end of the second arm 133 respectively. In some other embodiments, the position where the first arm 131 and the telescopic arm 135 are hinged with the second arm 133 may be located between two ends of the second arm 133. Also, the first arm 131 and the telescopic arm 135 may be not limited to being hinged to the second arm 133 at the ends of the first arm 131 and the telescopic arm 135, and may be hinged to the second arm 133 at positions apart from the ends.

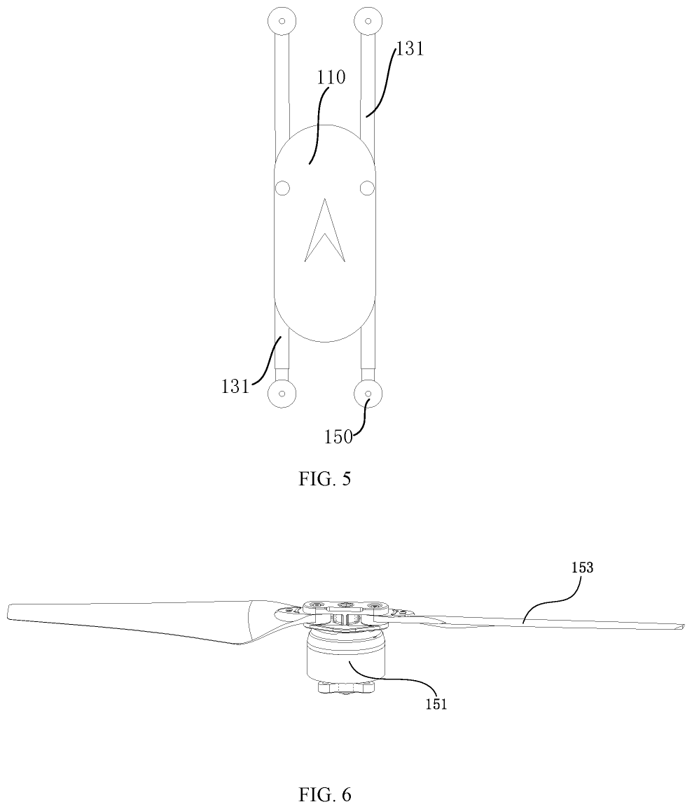

For each triangular arm 130 in FIGS. 2-3, a pushing force may be applied to the second arm 133 toward the center frame 110, to fold the triangular arm 130. For example, for the triangular arm 130 at the left side of the center frame 110, when a push force to the right is applied to the second arm 133, the left end of the first arm 131 and the left end of the telescopic arm 135 hinged to the end of the second arm 133 may rotate to the right side, to increase an angle between the first arm 131 and the telescopic arm 135. During the rotation, since the length of the second arm 133 is fixed, the telescopic arm 135 may retract to cushion the pushing force applied to the triangular arm 130. Correspondingly, the shape of the triangle formed by the first arm 131, the second arm 133 and the telescopic arm 135 may change with the retraction of the telescopic arm and the second arm 133 may be brought closer to the center frame 110. Similarly, for the triangular arm 130 at the right side of the center frame 110, the second arm 133 under a leftward pushing force may also bring the triangular arm 130 closer to the center frame 110. FIG. 5 illustrates a state that the triangular arms at the left and the right sides of the multi-rotor unmanned aerial vehicle illustrated in FIG. 2 are completely folded. After that the triangular arms at the left and the right sides of the center frame 110 are completely folded, for each triangular arm 130, the first arm 131, the second arm 133 and the telescopic arm 135 may be located under the center frame 110 and may be vertically overlapped. For description purposes only, the embodiment in FIG. 5 where the first arm 131, the second arm 133 and the telescopic arm 135 of each triangular arm 130 are vertically overlapped after folding is used as an example to illustrate the present disclosure, and should not limit the scopes of the present disclosure. In some other embodiments, the first arm 131, the second arm 133 and the telescopic arm 135 of each triangular arm 130 may be close to each other after folding and still form a triangle.

For description purposes only, the embodiment in FIGS. 2-3 where the second arm 133, the first arm 131 and the telescopic arm 135 of each triangular arm 130 are located under the center frame 110 after folding is used as an example to illustrate the present disclosure and should not limit the scopes of the present disclosure. In some other embodiments, the second arm 133, the first arm 131 and the telescopic arm 135 of each triangular arm 130 may be located above the center frame 110, or close to sidewalls of the center frame 110 after folding. For example, in one embodiment, the triangular arm 130 on the left side in FIG. 3 may be located against a left sidewall of the center frame 110 after folding.

An opposite force may be applied to the second arm 133 of each triangular arm 130 to pull the second arm 133 away from the center frame 110 and to expand the triangular arm 130.

Further, when the multi-rotor unmanned aerial vehicle 100 operates, to ensure that the expanded telescopic arm 135 of each triangular arm 130 does not retract under a pressure of air, a corresponding locking mechanism may be disposed at the telescopic arm 135 to lock the telescopic arm 135 after it is expanded and to avoid variations in its length. In various embodiments, the locking mechanism may be any suitable structure capable of locking. For example, the locking of the telescopic arm 135 after it is expanded may be achieved by locking catch, by a fixing pin and a pinhole, or by bolt tightening.

For each triangular arm 130, when the triangular arm 130 is expanded (that is, the telescopic arm 135 in the triangular arm 130 is expanded), the triangular formed by the triangular arm 130 may be an acute triangle, a right triangle, or an obtuse triangle. For example, for each triangular arm 130 in FIGS. 2-3, an angle between the second arm 133 and the telescopic arm 135 may be an acute angle, a right angle, or an obtuse angle. By selecting different triangular shapes, the unmanned aerial vehicle may have different appearance shapes and the position of the propulsion components 150 may be adjusted, to provide suitable flight efficiency of the multi-rotor unmanned aerial vehicle in different application scenarios or different loads.

For each triangular arm 130, a plane formed by the triangular arm 130 may be parallel to a horizontal plane, or may be oblique to the horizontal plane (that is, there may be an angle between the plane formed by the triangular arm 130 and the horizontal plane). In some embodiments, the second arm 133 may be disposed parallel to the horizontal plane, while the first arm 131 and the telescopic arm 135 may be disposed obliquely to the horizontal plane. For example, the first arm 131 and the telescopic arm 135 may be disposed obliquely upward. By disposing the triangular arm 130 obliquely, a height of the body and then a center of gravity of the multi-rotor unmanned aerial vehicle 100 may be lowered, and the stability of the multi-rotor unmanned aerial vehicle 100 may be improved in certain application scenarios.

For a relationship between different arms of each triangular arm 130 in the three-dimensional space, in some embodiments, the first arm 131, the second arm 133 and the telescopic arm 135 may be disposed in a same layer. Correspondingly, the first arm 131, the second arm 133 and the telescopic arm 135 may be located in one plane simultaneously, and the plane may be parallel to or oblique to the horizontal plane. In some other embodiments, the first arm 131, the second arm 133 and the telescopic arm 135 may be distributed in two layers. Any two of the first arm 131, the second arm 133, and the telescopic arm 135 may be located in a same plane, and another may be disposed adjacent to the plane (that is, another may be located outside the plane). For example, for each triangular arm 130 in FIGS. 1-3, the first arm 131 and the telescopic arm 135 may be located in a same plane, and the second arm 133 may be located under the plane. Correspondingly, the first arm 131, the second arm 133 and the telescopic arm 135 may form a two-layer structure. In some other embodiments, the first arm 131, the second arm 133 and the telescopic arm 135 may be distributed in three different layers. For example, when the plane formed by the triangular arm 130 is parallel to the horizontal plane, the first arm 131, the second arm 133 and the telescopic arm 135 may be disposed alternately along a perpendicular plane, and the first arm 131, the second arm 133 and the telescopic arm 135 may be located in three different layers in the perpendicular plane. In some other embodiments, in each triangular arm 130 oblique to the horizontal plane in FIG. 2, the first arm 131 or the telescopic arm 135 may be moved upwards or downwards for a certain distance, to make the first arm 131, the second arm 133 and the telescopic arm 135 located in three different layers in the perpendicular plane.

In some embodiments, in each triangular arm 130, the telescopic arm 135 may be formed by splicing a plurality of sleeves together, and the first arm 131 and the telescopic arm 135 may be hinged to the center frame 110 by a hinge shaft. The plurality of sleeves in the telescopic arm 135 can be retracted with a diameter same as or substantially same as a diameter of the hinge shaft. Correspondingly, the telescopic arm 135 and the hinge shaft may be approximately considered as one point.

In some embodiments, for each triangular arm 130, a length of the second arm 133 may be larger than a length of the first arm 131. When the first arm 131, the second arm 133 and the telescopic arm 135 are located in the same one layer (that is, the first arm 131, the second arm 133 and the telescopic arm 135 are located in the same one plane), the second arm 133 under the pushing force may push the first arm 133 and the telescopic arm 135 to rotate, to increase the angle between the first arm 133 and the telescopic arm 135 gradually to 180°. The second arm 133 and the first arm 131 may be in close contact with each other then. When the first arm 131, the second arm 133 and the telescopic arm 135 are located in two different layers (for example, the first arm 131 and the telescopic arm 135 are located in the same one plane, while the second arm 133 is disposed below the plane), the second arm 133 under the pushing force may push to increase the angle between the first arm 133 and the telescopic arm 135 gradually to 180°. The second arm 133 may be stacked below the first arm 131 then.

In some other embodiments, for each triangular arm 130, the length of the second arm 133 may be smaller than the length of the first arm 131. When the second arm 133 under the pushing force pushes the first arm 131 and the telescopic arm 135 to rotate, to make the triangular arm 130 return to the retracted state from the expanding state, the angle between the first arm 133 and the telescopic arm 135 may be kept smaller than 180°. Correspondingly, the first arm 131, the second arm 133 and the telescopic arm 135 may still form a triangle, while the triangle in the retracted state may be different from the triangle in the expanding state. When the length of the second arm 133 is smaller than the length of the first arm 131, the configuration that the triangular arm 130 in the retracted state still keeps a triangular shape can be used to not only the embodiments where the first arm 131, the second arm 133 and the telescopic arm 135 are located in the same one layer, but also the embodiments where the first arm 131, the second arm 133 and the telescopic arm 135 are located in two different layers or three different layers.

Considering a cost and a fabrication process, a length of the telescopic arm 135 in a maximum retracted state may be larger than a diameter of the hinging shaft. Correspondingly, when configuring the length of the second arm 133, the length of the telescopic arm 135 in a maximum retracted state can be considered appropriately. If the second arm 133 need to be in contact with or stacked with the first arm 131, the length of the second arm 133 may be configured to be larger than a sum of the length of the first arm 131 and the length of the telescopic arm 135 in a maximum retracted state.

As illustrated in FIGS. 1-3, propulsion components 150 may be disposed on the triangular arms 130 to provide the thrust force. For one triangular arm 130, the propulsion components 150 may be disposed on one or more of the first arm 131, the second arm 133, or the telescopic arm 135. In one embodiment, as illustrated in FIGS. 2-3, for one triangular arm 130, when the first arm 131 is hinged to the center frame 110, one or more propulsion components 150 may be disposed at the second arm 133. In some other embodiments, one or more propulsion components 150 may be disposed at the ends of the second arm 133. In some other embodiments, one, two, or more propulsion components 150 may be installed at hinging points between the second arm 133 and the other two arms, for one triangular arm 130. In other embodiments, one, two, or more propulsion components 150 may be disposed at the ends of the second arm 133, and at hinging points between the second arm 133 and other two arms, for one triangular arm 130. For one triangular arm 130, the hinging points between the second arm 133 and the first arm 131, and the hinging points between the second arm 133 and the telescopic arm 135 may be located at two ends of the second arm 133, or located between the two ends of the second arm 133.

In the following, the embodiments illustrated in FIGS. 2-3 where the propulsion components 150 are disposed on the second arms 133 will be used as examples to illustrate the present disclosure, and should not limit the scopes of the present disclosure. In various embodiments, the propulsion components 150 may be disposed on the first arm 131, on the telescopic arm 135, or on two or three of the first arm 131, the second arm 133 and the telescopic arm 135, for one triangular arm 130.

FIG. 6 illustrates a propulsion component 150 of a multi-rotor unmanned aerial vehicle consistent with various embodiments of the present disclosure. As illustrated in FIG. 6, the propulsion component 150 may include a motor 151 and a propeller 153.

The motor 151 may be fixed on the second arm 133 of a triangular arm 130. The propeller 153 may be connected to an output shaft of the motor 151. An electricity tune for controlling the motor 151 may be mounted in the second arm 133 or in the center frame 110. For example, the second arm 133 may be a carbon fiber tube, and a groove may be formed at an end of the carbon fiber tube. The motor 151 may be disposed in the groove, and the electricity tune may be disposed in the carbon fiber tube or in the center frame 110 and may be connected to the motor 151 for communication through a connection wire.

In some embodiments, the motor 151 may be fixed to the second arm 133 through a motor mount base 155. The propeller 153 may be drivingly connected to the output shaft of the motor 151. The electricity tune for controlling the motor 151 may be disposed on the motor mount base 155, in the second arm 133, or in the center frame 110. In one embodiment, the electricity tune may be integrated into the motor mount base 155, to reduce the length of the connection wire. Correspondingly, a transmitting time of electricity tune signals may be reduced and a controlling efficiency of the motor 151 may be improved. Further, a number of components in the unmanned aerial vehicle and weight of the frame may be reduced. In some embodiments, the motor mount base 155 can rotate around the second arm 133. When operating, the motor mount base 155 may be manually or automatically controlled to rotate around the second arm 133, to change an angle between the propeller 153 and the ground plane. When the motor mount base 155 is configured to be capable of rotating around the second arm 133, the appropriate lifting force can be achieved by adjusting the angle of the propeller 153 at different climbing state, different wind directions, or different operating environments.

The propeller 153 mounted on the output shaft may face the ground or face away from the ground, to suit different purposes or different application scenarios.

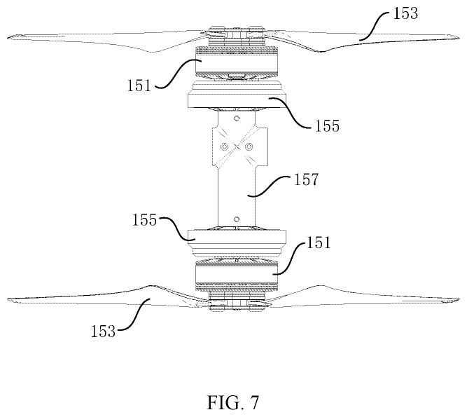

FIG. 7 illustrates another propulsion component 150 of a multi-rotor unmanned aerial vehicle consistent with various embodiments of the present disclosure. The propulsion component 150 may include two motors 151, two propellers 153, and a connecting shaft 157.

A motor 151 may be mounted at each end of the connecting shaft 158. For each motor 151, the output shaft may be connected to one propeller 153. A through-hole may be formed at an end of the second arm 133. The connecting shaft 157 may pass through the through-hole and may be fixed to the second arm 133. In some embodiments, the motors 151 may be fixed to the ends of the connection shaft 157 respectively through the motor mount base 155. The electricity tune may be integrated into the motor mount base 155. By the two motors 151 and the two propellers 157 coaxially mounting on the connection shaft 157, the output power of the propulsion component 150 may be improved, and the lifting force provided by the propulsion component 150 may be enhanced. Correspondingly, a flight efficiency of the multi-motor unmanned aerial vehicle may be improved, to load more or heavier goods.

As illustrated in FIGS. 2-3, hinging apexes where the first arms 131, the telescopic arm 135 and the center frame 110 are hinged together may be located at two sides of the longitudinal axis of the center frame. That is, each hinging apex may have a certain distance from the longitudinal axis of the center frame 110 or the hinging apexes may be disposed on the longitudinal axis of the center frame 110. In some embodiments, the second arms 133 may be disposed parallel to the longitudinal axis of the center frame 110. The above positional relationship between the hinging apexes and the longitudinal axis of the center frame 110 may also be applied to a positional relationship between the hinging apexes and the transverse axis of the center frame 110. By controlling the position of the hinging apexes, other structures such as the stand may be kept clear and the folded position of the triangle arms 130 can be adjusted to improve the convenience of the folded multi-rotor unmanned aerial vehicle 100 during storage.

A hinging apex between a triangular arm 130 and the center frame 110 may not be limited to a hinging apex between the first arm 131 and the telescopic arm 135. In some embodiments, the hinging apex between a triangular arm 130 and the center frame 110 may be a hinging apex between the first arm 131 and the second arm 133, or a hinging apex between the second arm 133 and the telescopic arm 135. The position of the propulsion component 150 may be adjusted accordingly.

In some embodiments illustrated in FIGS. 2-3, the multi-rotor unmanned aerial vehicle may include two triangular arms 130. The two triangular arms 130 may be disposed at two sides of the longitudinal axis of the center frame 110 symmetrically. In some other embodiments, the two triangular arms 130 may be disposed at two sides of the longitudinal axis of the center frame 110 asymmetrically. In some other embodiments, two triangular arms 130 may be disposed at two sides of the transverse axis of the center frame 110 symmetrically or asymmetrically. By disposing the two triangular arms 130 at two sides of an axis of the center frame 110 (the transverse axis or the longitudinal axis of the center frame 110) symmetrically, the smoothness of the multi-rotor unmanned aerial vehicle 100 during flight may be improved. By disposing the two triangular arms 130 at two sides of an axis of the center frame 110 (the transverse axis or the longitudinal axis of the center frame 110) asymmetrically, the center of gravity of the multi-rotor unmanned aerial vehicle 100 can be adjusted to improve the ability of the multi-rotor unmanned aerial vehicle 100 to carry irregular items.

In the present disclosure, by pushing the telescopic arm of a triangular arm in the multi-rotor unmanned aerial vehicle to make the telescopic arm retracted, the triangular arm may be folded toward the center frame. Correspondingly, the volume of the frame may be reduced to facilitate the storage and the transportation of the multi-rotor unmanned aerial vehicle. By pulling the telescopic arm of a triangular arm to make the telescopic arm extended, the triangular arm may be extended, and the multi-rotor unmanned aerial vehicle can operate normally.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments but may be embodied in other equivalent forms without departing from the scope of the present disclosure, which is determined by the appended claims.

What is claimed is:

1. A frame, comprising a triangular arm and a center frame, wherein:
an apex of the triangular arm is hinged with the center frame;
the triangular arm includes a first arm, a second arm, and a telescopic arm, wherein the first arm, the second arm, and the telescopic arm are hinged together to form a triangle;
when the telescopic arm is moved from an extended state to a retracted state, the triangular arm is folded toward a direction close to the center frame.

2. The frame according to claim 1, wherein a length of the first arm is smaller than a length of the second arm.

3. The frame according to claim 1, wherein, when the telescopic arm is in the extended state, the triangular arm is an acute triangle, a right triangle, or an obtuse triangle.

4. The frame according to claim 1, wherein:
the first arm, the second arm, and the telescopic arm are located in a same plane; or any two of the first arm, the second arm, and the telescopic arm are located in a same plane, and another one is disposed adjacent to the plane; or the first arm, the second arm, and the telescopic arm are located in three different layers respectively.

5. The frame according to claim 1, wherein:
propulsion components are disposed on the triangular arm.

6. The frame according to claim 5, wherein:
the first arm is hinged with the center frame; and
corresponding propulsion components are disposed on the second arm, at ends of the second arm, or between a hinging point where the second arm is hinged with the first arm and a hinging point where the second arm is hinged with the telescopic arm.

7. The frame according to claim 5, wherein:
a hinging point where the first arm is hinged with the telescopic arm is located between two ends of the second arm.

8. The frame according to claim 5, wherein:
each propulsion component includes a motor and a propeller, wherein the propeller is connected to an output shaft of the motor and the motor is fixed to corresponding one of the triangular arms.

9. The frame according to claim 1, wherein:
a hinging point where the triangular arm is hinged with the center frame is located at an axis of the center frame, or is apart from an axis of the center frame by a certain distance.

10. The frame according to claim 1, wherein:
the frame includes two of the triangular arm.

11. The frame according to claim 10, wherein:
the two of the triangular arm are symmetrical or asymmetrical with respect to an axis of the center frame.

12. The frame according to claim 1, wherein:
an apex formed by hinging the first arm to the telescopic arm is hinged with the center frame.

13. The frame according to claim 12, wherein:
the second arm is parallel to a longitudinal axis of the center frame.

14. The frame according to claim 12, wherein:
when the telescopic arm is in the extended state, an angle between the second arm and the telescopic arm is an acute angle, a right angle, or an obtuse angle.

15. The frame according to claim 12, wherein:
the first arm, the second arm, and the telescopic arm are hinged together through a rotary shaft.

16. A multi-rotor unmanned aerial vehicle, comprising a frame and a stand, wherein:
the frame includes a triangular arm and a center frame;
an apex of the triangular arm is hinged with the center frame;
the triangular arm includes a first arm, a second arm, and a telescopic arm, wherein the first arm, the second arm, and the telescopic arm are hinged together to form a triangle;
when the telescopic arm is moved from an extended state to a retracted state, the triangular arm is folded toward a direction close to the center frame; and
the stand is mounted at a bottom of the center frame.

17. The multi-rotor unmanned aerial vehicle according to claim 16, wherein a length of the first arm is smaller than a length of the second arm.

18. The multi-rotor unmanned aerial vehicle according to claim 16, wherein:
the first arm, the second arm, and the telescopic arm are located in a same plane; or any two of the first arm, the second arm, and the telescopic arm are located in a same plane, and another one is disposed adjacent to the plane; or the first arm, the second arm, and the telescopic arm are located in three different layers respectively.

19. The multi-rotor unmanned aerial vehicle according to claim 10, wherein the frame includes two triangular arms.

20. The multi-rotor unmanned aerial vehicle according to claim 10, wherein an apex formed by hinging the first arm to the telescopic arm is hinged with the center frame.
